(19) United States
(12) Patent Application Publication
(10) Pub. No.: US 2015/0167872 A1
(43) Pub. Date: Jun. 18, 2015

(54) ELEMENT OF A CLAMP/FLANGE CONNECTION

(71) Applicant: NORMA GERMANY GMBH, Maintal (DE)

(72) Inventors: Gerrit von BREITENBACH, Karlstein (DE); Michael LENZ, Schoeneck (DE)

(73) Assignee: NORMA GERMANY GMBH, Maintal (DE)

(21) Appl. No.: 14/553,259

(22) Filed: Nov. 25, 2014

(30) Foreign Application Priority Data
Dec. 16, 2013 (DE) 102013114080.7

(51) Int. Cl. F16L 23/10

(52) U.S. Cl. CPC F16L 23/10

(57) ABSTRACT

Element of a clamp/flange connection, which includes at least one surface structured to bear against a mating surface. The surface includes a lubricating layer.

### CROSS-REFERENCE TO RELATED APPLICATIONS

The present application claims priority under 35 U.S.C. §119 of German Patent Application No. DE 10 2013 114 080.7, filed Dec. 16, 2013, the disclosure of which is expressly incorporated by reference herein in its entirety.

### BACKGROUND OF THE EMBODIMENTS

1. Field of the Invention

Embodiments of the invention relate to an element of a clamp/flange connection, having at least one surface which can be brought to bear against a mating surface.

2. Discussion of Background Information

Embodiments are described below on the basis of a “coned flange connection.”

In a coned flange connection, each of the two components that are to be connected to one another include, at the ends that are to be connected together, a flange directed radially outwards which includes a sloped back side. When the two components have been brought into contact with one another and the flanges have been aligned with one another, then a profile clamp can be placed onto the flanges so that the inner surfaces of the profile clamp flanks bear against the sloped back sides of the flanges. If the clamping band is then tightened by the tensioning device, then the inner diameter of the clamping band decreases and the flanks move radially inwards on the sloped sides of the flange. In this manner, a tension force is produced in an axial direction, which tension force braces the two components against one another.

A profile clamp suitable for this purpose is known from DE 10 2009 039 862 B4, for example.

If the production of higher axial forces is desired, for example, for securely compressing a seal between the two components to be connected, a larger or more thickly sized profile clamp must normally be used, so that a greater effort is also necessary for producing higher axial forces.

### SUMMARY OF THE EMBODIMENTS

Embodiments of the invention produce high tension forces with little work.

According to embodiments, an element of the type named at the outset include a surface having a lubricant layer.

The lubricant layer reduces the friction between the surface and the mating surface so that, in the example of the coned flange connection, friction is reduced between the inner surfaces of the flanks and the surfaces of the flanges against which the flanks bear. Thus, less tension force is required in order to move the flanks radially inwards, since the friction which must be overcome is smaller. In this manner, a greater portion of the tension force produced by the tensioning device can be converted into an axial force. Moreover, the lubricant layer has the advantage that the axial forces are distributed more uniformly in a circumferential direction of the profile clamp. When the clamping band is tightened by the tensioning device, not only do the flanks move radially inwards on the flanges, but a small movement in a circumferential direction of the clamping band is also necessary. Since this movement is also facilitated by the lubricant layer, the tension force produced by the tensioning device can also act in positions located at a greater distance from the tensioning device. Thus, a relatively uniform distribution of the generated axial force can be produced across the clamp circumference. The lubricant layer causes the friction between the inner surfaces of the flanks and the sides of the flanges against which the flanks bear to be less than is the case without a lubricant layer. Since the lubricant layer often separates the material of the flanks from the material of the flanges, the risk of contact corrosion is reduced and there results an improved corrosion resistance. Overall, there results a more stable, reliable process window for the assembly and the operation of the profile clamp by a good reproducibility of a coned flange connection achieved with the profile clamp.

Preferably, the element is embodied or formed as a profile clamp with a clamping band, which includes a base and flanks directed radially inwards having inner surfaces, and a tensioning device. The clamping band at least on the inner surface of the flanks comprises the lubricant layer. When the profile clamp is placed onto the flanges, the inner surface of the profile clamp and the outer surface of the flanges bear against one another. The desired friction reduction is achieved by the lubricant layer.

Preferably, the base also includes the lubricant layer on its inner surface. This facilitates the production of the profile clamp. The inner surface can be provided overall with the lubricant layer.

Here, it is preferred that the clamping band also includes the lubricant layer on its outer surface. The lubricant layer can then be simply applied in that the clamping band is dipped into a solution which then forms the lubricant layer. The production costs can thus be kept small.

Alternatively or additionally, the element can also be embodied or formed as a flange. In this case, the lubricant layer is located on the outer surface of the flange, against which the clamp bears. An embodiment of this type then also achieves a reduced friction so that the tension forces can be converted into axial forces to a greater extent.

Finally, it is also possible to alternatively or additionally embody or form the element as an intermediate element between the clamp and the flange. Although an additional element is needed in this case, this additional element can also advantageously be used with conventional clamp/flange connections, for which still no measures for decreasing friction have been taken up to now.

Preferably, the lubricant layer is not volatile. The lubricant layer thus also remains present after a lengthier storage, without losing its lubricating properties. This facilitates the stocking of inventory.

Preferably, the lubricant layer is stable up to a predefined temperature. The predefined temperature is based on the intended use. For example, if the profile clamp is used to connect parts of an exhaust gas line of a combustion engine to one another, then the lubricant layer can, for example, be designed to be stable up to a temperature of at least 1000° C. It then prevents a “baking” of the profile clamp to the flanges.

Preferably, the lubricant layer is embodied or formed as a dry layer. A dry layer has the advantage that it does not leave behind any traces on contact with other parts. Furthermore, the risk is low that dust or foreign objects firmly adhere to the lubricant layer and thus counteract the friction reduction. In addition, the stocking of inventory is also facilitated.

Here, it is preferred that the lubricant layer is embodied or formed as a dry lubricant. A dry lubricant allows a low-friction sliding without being perceived as greasy, highly viscous, or wet.

Preferably, the lubricant layer is embodied or formed as a solid lubricant. In this case, friction-reducing effects of a solid lubricant, for example graphite, tin or molybdenum disulfide, can be taken advantage of.

In an alternative or additional embodiment, the lubricant layer can be embodied or formed as a lacquer layer. A lacquer layer can be easily applied.

Finally, it is also possible that the lubricant layer includes a plastic. For example, polytetrafluoroethylene (PTFE) can be used as plastic. Furthermore, materials from the group of high-strength thermoplastic materials on the basis of polyaryletherketones, in particular polyetheretherketones, polyamides, polyacetals, polyarylethers, polyethylene terephthalates, polyphenylene sulfides, polysulfones, polyethersulfones, polyetherimides, polyamide imides, polyacrylates, phenolic resins, such as novolac resins or the like, come into consideration. With plastics of this type, there results an outstanding gliding behavior of the flanks on the flanges.

In a preferred embodiment, the lubricant layer is embodied or formed as a sheet or a film.

Embodiments of the invention are directed to an element of a clamp/flange connection, which includes at least one surface structured to bear against a mating surface. The surface includes a lubricating layer.

In accordance with embodiments, the element can be embodied as a profile clamp with a clamping band, in which the clamping band includes a base and radially inwardly directed flanks having inner surfaces, and a tensioning device. The clamping band, at least on the inner surface of the flanks, can include the lubricant layer. An inner surface of the base may also include the lubricant layer. The clamping band can also include the lubricating layer on an outer surface.

According to embodiments, the element can be embodied as a flange.

In other embodiments, the element can be embodied as an intermediate element between the clamp and the flange.

Further, the lubricant layer can be not volatile.

According to still further embodiments, the lubricant layer can be stable up to a predefined temperature. The predefined temperature may be at least 1000° C.

In other embodiments, the lubricant layer may include a dry layer. The lubricant layer can also include a dry lubricant.

In still other embodiments, the lubricant layer may be embodied a solid lubricant.

According to still other embodiments, the lubricant layer may be embodied as a lacquer layer.

According to other embodiments, the lubricant layer can include a plastic.

In accordance with embodiments, the lubricant layer is embodied as a sheet or a film.

Embodiments of the invention are directed to a method of forming a clamp/flange connection that includes forming a lubricant layer on a surface arranged to bear against a mating surface.

According to embodiments, the surface can be an inner surface of a clamping element and the mating surface may be a back side of a flange. Further, a radial inward sliding of the surface relative to the back side of the flange may produce an axial force on the flange.

According to embodiments, the surface may be a back side of a flange and the mating surface can be an inner surface of a clamping element.

In accordance with still yet other embodiments of the present invention, the surface can be located on an intermediate layer positionable between the clamp and flange, and the mating surface may be one of the clamp and flange.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic representation of a profile clamp; and

FIG. 2 shows a schematic section view of a coned flange connection.

### DETAILED DESCRIPTION OF THE PRESENT EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

FIG. 2 shows in a strongly schematized representation a section of a coned flange connection 11 that connects a first component 12 to a second component 13. The two components 12, 13 can, for example, be pipes or pipe connections.

The first component 12 comprises a flange 14 protruding radially outwards which is sloped on its back side 15, which faces away from the second component 13. The flange 14 is in this case embodied or formed with a trapezoid shape in cross section, that is, it is also sloped on its front side 16, which faces the second component 13.

The second component 13 also has a flange 17. This flange 17 comprises a back side 18, which faces away from the first component 12 and a front side 19, which faces the first component 12. The slope of the front side 16 of the first flange 14 and the slope of the front side 19 of the second flange 17 correspond to one another, so that the two flanges 14, 17 can be positioned against one another without an intermediate space.

The flanges 14, 17 can also be embodied or formed in a different manner, for example, with flat front sides.

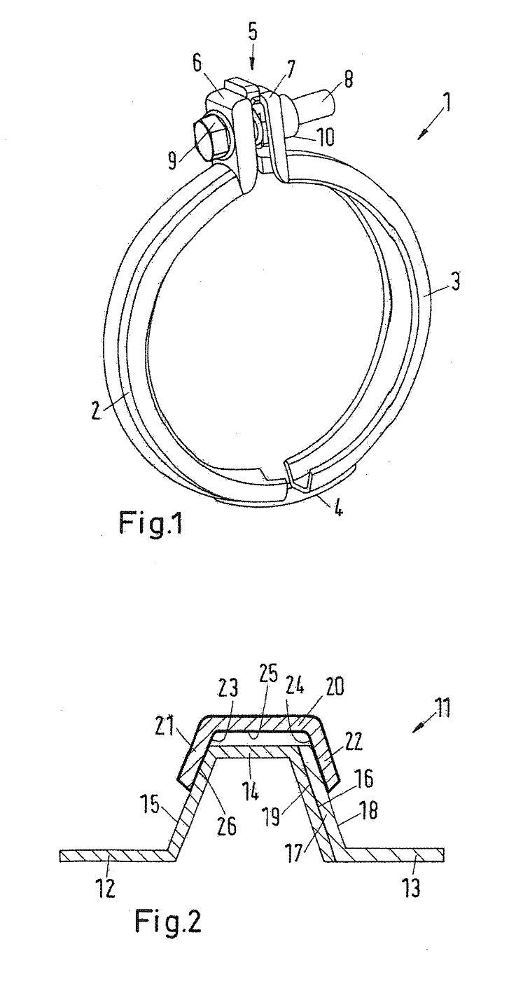

To connect the two flanges 14, 17, a profile clamp 1 is provided which is illustrated in perspective in FIG. 1.

The profile clamp 1 comprises a clamping band which in the present case is embodied or formed with two clamping sections 2, 3. It is possible to use more than two clamping sections 2, 3. It is also possible to embody or form the clamping band in one piece.

The two clamping sections 2, 3 are connected to one another by a bridge 4, which can be embodied or formed in a springable manner.

The bridge 4 is arranged at an end of the clamping sections 2, 3 in a circumferential direction. At the other end of the clamping sections 2, 3, a tensioning device 5 is provided. Here, the clamping section 2 comprises a clamping head 6. The clamping section 3 comprises a clamping head 7. The two clamping heads 6, 7 are connected to one another by a bolt 8 which comprises a head 9 on one side and is screwed through a nut 10 with its other end. Of course, other forms of tensioning devices are possible.

To assemble the profile clamp 1, the bolt 8 is screwed out of the nut 10 so that the two clamping sections 2, 3 can be moved away from one another on the opposite side of the bridge 4. The profile clamp 1 can then be guided over the parts that are to be connected. The bolt 8 is screwed into the nut 10. During the screwing, the two clamping jaws 6, 7 move towards one another so that the inner diameter of the clamping band decreases.

As mentioned above, the profile clamp 1 comprises a clamping band, which is illustrated in section in FIG. 2. The clamping band comprises a base 20 and flanks 21, 22 directed radially towards the inside or directed radially inwards. The flanks 21, 22 extend from the base 20 and are preferably embodied or formed in one piece with the base 20. They can, for example, be bent back from the base 20.

The flanks 21, 22 comprise inner surfaces 23, 24. The base 20 has an inner surface 25.

If the two components 12, 13 have been aligned with one another such that the two flanges 14, 17 bear against one another as illustrated, then the profile clamp can be positioned over the two flanges 14, 17 so that the flanks 21, 22 bear with their inner surfaces 23, 24 against the two back sides 15, 18 of the flanges 14, 17. If the clamping band is then tightened by the tensioning device 5 and the inner diameter of the clamping band decreases, then the two flanks 21, 22 move radially inwards on the back sides 15, 18 of the flanges 14, 17 so that an axially acting force is applied to the two flanges 14, 17, which presses the two components 12, 13 against one another in an axial direction.

At least the inner surfaces 23, 24 of the flanks 21, 22 are covered with a lubricant layer 26. This lubricant layer 26 is in this case illustrated as a thick black line, however, this illustration is not to scale.

Preferably, not only are the inner surfaces 23, 24 of the flanks 21, 22 covered with the lubricant layer, but also the inner surface 25 of the base 20.

In a particularly preferred embodiment, the entire clamping band can even comprise a lubricant layer which, for example, has possibly been applied by a dipping procedure. This can be seen in the schematic illustration in FIG. 2.

The lubricant layer can also be applied in a different manner, for example, by sputtering or spraying or by deposition from electrolytic or chemical baths in which the profile clamp 1 can, for example, acquire Ni—Sn layers, Sn layers, phosphate layers or the like.

Several effects are achieved by the lubricant layer 26: Friction during the movement of the flanks 21, 22 radially inwards on the flanges 14, 17 is reduced. The lubricant layer 26 causes the friction between the inner surfaces 23, 24 and the back sides 15, 18 to be less than when the flanks 21, 22 are directly brought into contact with the flanges 14, 17. For this reason, a larger portion of the tension force produced using the tensioning device 5 can be converted into an axially acting force which presses the two components 12, 13 against one another. An enlargement or a thicker sizing of the profile clamp 1 or the tensioning device is not necessary for this purpose.

Moreover, the lubricant layer 26 also achieves a better distribution in a circumferential direction of the tension force produced using the tensioning device 5, since the profile clamp has to overcome a lower friction in a circumferential direction as a result of the lubricant layer 26, even during a movement of the flanks 21, 22 relative to the flanges 14, 17. A movement of this type automatically results when the tensioning device 5 is tightened. Without the lubricant layer 26, an increased portion of the axial force can be observed in the proximity of the tensioning device 5. With the lubricant layer 26, the distribution of the axial force in the circumferential direction becomes more uniform and the axial tension force of the profile clamp 1 will be significantly higher with an otherwise equal force introduced by the tensioning device 5.

If the lubricant layer 26 is embodied or formed as a separating layer, then it prevents a direct contact between the flanks 21, 22 and the flanges 14, 17 so that the risk of contact corrosion is lower.

The lubricant layer 26 is preferably not volatile. It therefore remains preserved, even during a lengthier storage, and produces its friction-reducing effect during the assembly.

If the profile clamp 1 is to be used in a region with an increased temperature, it may also be advantageous, depending on the desired application, if the lubricant layer 26 is stable up to a predefined temperature. A case of this type occurs, for example, when the profile clamp is used to connect parts of an exhaust gas line system of a combustion motor to one another. In this case, it can be advantageous if the lubricant layer 26 is stable up to a temperature of at least 1000° C., for example. In this case, a “baking” of the profile clamp 1 to the parts of the exhaust gas line system is prevented and a replacement of the profile clamp 1 is facilitated.

The lubricant layer 26 is embodied or formed as a dry layer, that is, it leaves behind no traces when it comes into contact with other parts or with the hand of a fitter. Preferably, it has been embodied or formed as a dry lubricant.

It can also be embodied or formed as a solid-based layer, for example, a graphite-based layer.

The lubricant layer 26 can also be embodied or formed as a lacquer layer, a sheet or a film.

The lubricant layer 26 can comprise molybdenum disulfide.

The lubricant layer 26 can comprise a plastic, for example, polytetrafluoroethylene or materials from the group of high-strength thermoplastic materials on the basis of polyaryletherketones, in particular polyetheretherketones, polyamides, polyacetals, polyarylethers, polyethylene terephthalates, polyphenylene sulfides, polysulfones, polyethersulfones, polyetherimides, polyamide imides, polyacrylates, phenolic resins, such as novolac resins or the like.

Of course, it is not only possible to embody or form the lubricant layer 26 on the profile clamp 1. The flanges 14, 17 can also, at least on the back sides 15, 18 thereof, be provided with a corresponding lubricant layer, and the same effect is thus achieved, namely a low friction between the profile clamp and the flanges 14, 17 when the profile clamp 1 is tightened.

Finally, it is also possible to introduce in a manner not illustrated in greater detail an intermediate element between the flanks 21, 22 and the back sides 15, 18 of the flanges 14, 17. This intermediate element can be provided with a lubricant layer or this intermediate element can then be formed from a lubricant, so that a lubricant layer is also present in this case in order to keep the friction between the flanks 21, 22 and the back sides 15, 18 of the flanges 14, 17 small.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An element of a clamp/flange connection, comprising:
at least one surface structured to bear against a mating surface,
wherein the surface comprises a lubricating layer.

2. The element according to claim 1 that is embodied as a profile clamp with a clamping band, the clamping band including a base and radially inwardly directed flanks having inner surfaces, and a tensioning device,
wherein the clamping band, at least on the inner surface of the flanks, comprises the lubricant layer.

3. The element according to claim 2, wherein an inner surface of the base also comprises the lubricant layer.

4. The element according to claim 3, wherein the clamping band also comprises the lubricating layer on an outer surface.

5. The element according to claim 1 being embodied as a flange.

6. The element according to claim 1 being embodied as an intermediate element between the clamp and the flange.

7. The element according to claim 1, wherein the lubricant layer is not volatile.

8. The element according to claim 1, wherein the lubricant layer is stable up to a predefined temperature.

9. The element according to claim 8, wherein the predefined temperature is at least 1000° C.

10. The element according to claim 1, wherein the lubricant layer comprises a dry layer.

11. The element according to claim 10, wherein the lubricant layer comprises a dry lubricant.

12. The element according to claim 1, wherein the lubricant layer is embodied a solid lubricant.

13. The element according to claim 1, wherein the lubricant layer is embodied as a lacquer layer.

14. The element according to claim 1, wherein the lubricant layer comprises a plastic.

15. The element according to claim 1, wherein the lubricant layer is embodied as a sheet or a film.

16. A method of forming a clamp/flange connection, comprising:
forming a lubricant layer on a surface arranged to bear against a mating surface.

17. The method according to claim 16, wherein the surface is an inner surface of a clamping element and the mating surface is a back side of a flange.

18. The method according to claim 16, wherein a radial inward sliding of the surface relative to the back side of the flange produces an axial force on the flange.

19. The method according to claim 16, wherein the surface is a back side of a flange and the mating surface is an inner surface of a clamping element.

20. The method according to claim 16, wherein the surface is located on an intermediate layer positionable between the clamp and flange, and the mating surface is one of the clamp and flange.
